(19) United States
(12) Patent Application Publication
(10) Pub. No.: US 2026/0282039 A1
(43) Pub. Date: Sep. 17, 2026

(54) METHOD, DEVICE AND COMPUTER READABLE MEDIUM FOR SIDELINK COMMUNICATIONS

(71) Applicant: NEC Corporation, Tokyo (JP)

(72) Inventors: Zhaobang MIAO, Beijing (CN); Jin YANG, Beijing (CN); Gang WANG, Beijing (CN)

(73) Assignee: NEC Corporation, Tokyo (JP)

(21) Appl. No.: 18/872,023

(22) PCT Filed: Jun. 10, 2022
(86) PCT No.: PCT/CN2022/098063

§ 371 Date: Dec. 5, 2024

(51) Int. Cl. H04W 72/25

(52) U.S. Cl. CPC H04W 72/25

(57) ABSTRACT

Embodiments of the present disclosure relate to method, device and computer readable media for sidelink communications. A method implemented at a first terminal device for sidelink communications comprises: in accordance with a determination that a first candidate resource immediately preceding a second resource is available in a candidate resource set, selecting the first candidate resource for the sidelink communications. The second resource is reserved by a second terminal device. The method also comprises obtaining a COT duration before performing the sidelink communications on the first candidate resource. The method further comprises transmitting first information about the COT duration to the second terminal device.

### TECHNICAL FIELD

Embodiments of the present disclosure generally relate to the field of telecommunication, and in particular, to a method, device and computer readable media for sidelink communications.

### BACKGROUND

Sidelink in unlicensed spectrum or band (SL-U) is to be studied in Release 18 sidelink evolution work item of the 3rd Generation Partnership Project (3GPP). The scheme of SL-U should be based on New Radio (NR) sidelink and NR-U.

In sidelink communications, there are two modes of resource allocation. In a first mode (also referred to as NR sidelink mode 1 or mode 1 hereinafter), one terminal device may perform sidelink communications with the other terminal device by using resources allocated by a network device. In a second mode (also referred to as NR sidelink mode 2 or mode 2 hereinafter), one terminal device may perform sidelink communications with the other terminal device by using resources autonomously selected in a resource pool by the one terminal device.

### SUMMARY

In general, example embodiments of the present disclosure provide methods, devices and computer readable media for sidelink communications.

In a first aspect, there is provided a method implemented at a first terminal device for sidelink communications. The method comprises: in accordance with a determination that a first candidate resource immediately preceding a second resource is available in a candidate resource set, selecting the first candidate resource for the sidelink communications. The second resource is reserved by a second terminal device. The method also comprises obtaining a Channel Occupancy Time (COT) duration before performing the sidelink communications on the first candidate resource. The method further comprises transmitting first information about the COT duration to the second terminal device.

In a second aspect, there is provided a method for sidelink communications. The method comprises: performing, at a first terminal device, a transmission on a first resource; and in accordance with a determination that a positive acknowledge to the transmission is received or no negative acknowledge to the transmission is received from a second terminal device, performing a retransmission associated with the transmission on a second resource to the second terminal device, the second resource being within a COT duration.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in accordance with some embodiments of the present disclosure;

FIG. 4 illustrates an example of a sensing window and a selection window in a sensing and resource selection procedure;

FIG. 5 illustrates a flowchart of an example method in accordance with some embodiments of the present disclosure;

FIGS. 6A, 6B, 7 and 8 illustrate an example of a resource selection in accordance with some embodiments of the present disclosure, respectively;

FIG. 9 illustrates a flowchart of an example method in accordance with some other embodiments of the present disclosure;

FIGS. 10A and 10B illustrate a flowchart of an example method in accordance with still other embodiments of the present disclosure, respectively; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

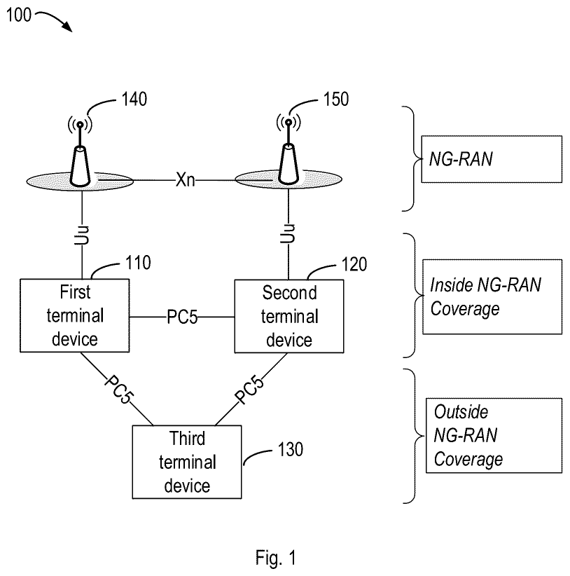

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e.

Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

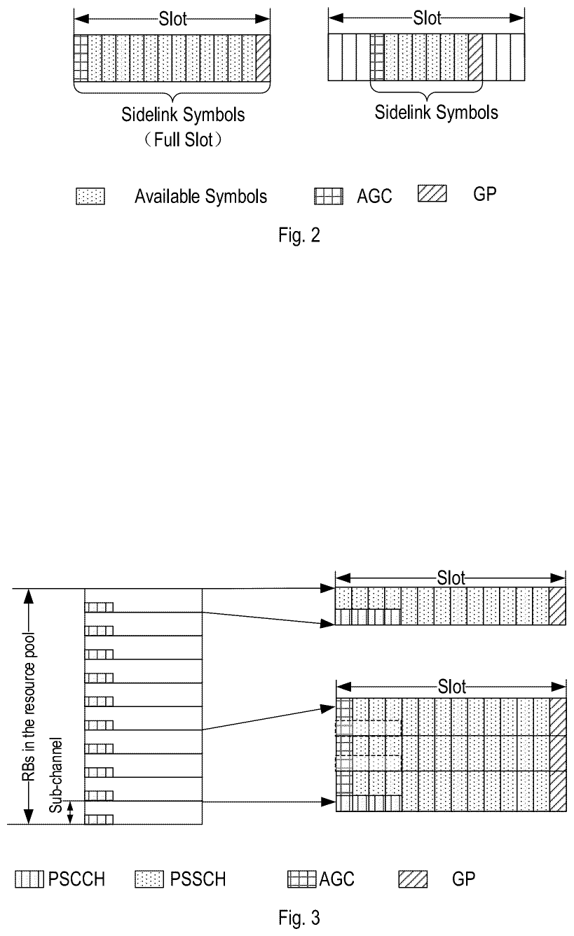

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The first terminal device 110, the second terminal device 120 and the third terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink Hybrid Automatic Repeat Request (HARQ) feedback information, a physical sidelink broadcast channel (PSBCH) resource which is used for carrying sidelink broadcast information, and a physical sidelink discovery channel (PSDCH) resource which is used for carrying a sidelink discovery signal. Hereinafter, a PSFCH resource is also referred to as a feedback channel resource or HARQ feedback opportunity.

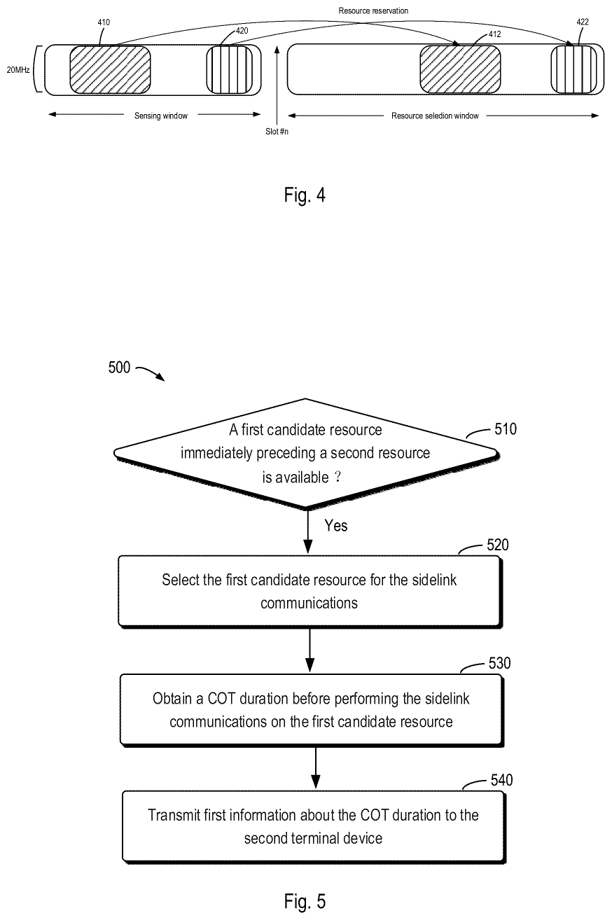

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the first terminal device 110, the second terminal device 120 and the third terminal device 130 uses the PSSCH resource to send sidelink information, it can use one or more sub-channels to carry corresponding data information. A PSCCH resource includes t symbols in time domain, and l RBs in frequency domain. Each PSCCH channel resource is located at consecutive t symbols starting from the first symbol in the available symbols in the time domain, and located at the position of consecutive 1 RBs starting from the first RB in the corresponding sub-channel in the frequency domain, as shown in FIG. 3.

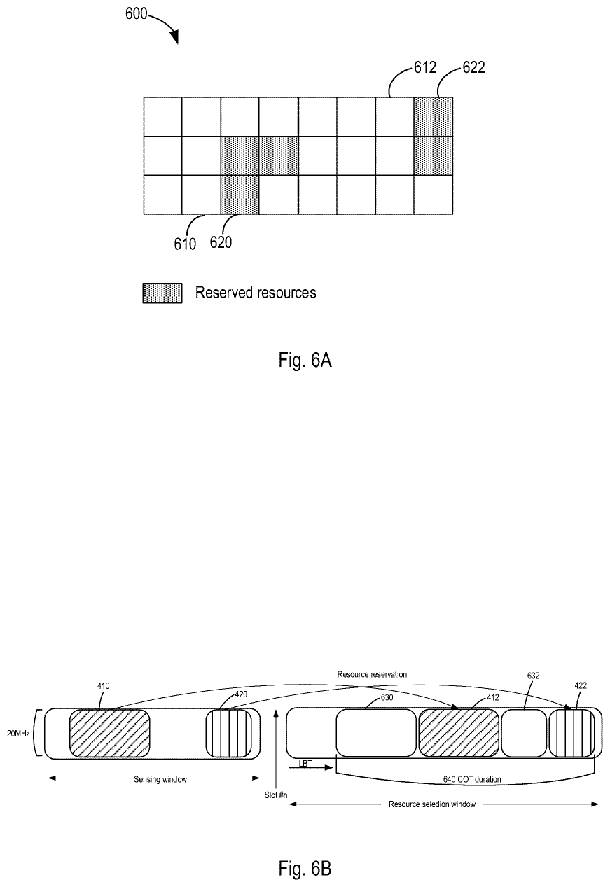

A terminal device may select resources from its transmission resource pool for sidelink signal transmission by performing a sensing and resource selection procedure. FIG. 4 illustrates an example of a sensing window and a selection window in a sensing and resource selection procedure. As shown, a sensing and resource selection procedure may be triggered in slot #n. During the procedure, the first terminal device 110 senses resources within a sensing window in a resource pool and tries to decode SCI 410 received from the second terminal device 120 and SCI 420 received from the third terminal device 130. The SCI 410 may comprise control information indicating a candidate resource 412 reserved by the second terminal device 120. The SCI 420 may comprise control information indicating a candidate resource 422 reserved by the third terminal device 130.

Then, based on measurement results and control information obtained from the SCI 410 and 420, the first terminal device may exclude the candidate resources 412 and 422 from an initial set of candidate resources within the resource selection window. Thus, the first terminal device 110 may determine the remaining candidate resources within the resource selection window as a candidate resource set and report the set to a high layer of the first terminal device 110. Hereinafter, the candidate resource set with at least one reserved resource being excluded is also referred to as a sensing result.

Upon receiving the candidate resource set, the high layer of the first terminal device 110 may select at least one candidate resource from the candidate resource set for sidelink communications.

If the high layer of the first terminal device 110 randomly selects a candidate resource from the candidate resource set, a pattern of consecutive resources for the first terminal device 110 and the second terminal device 120 and/or the third terminal device 130 cannot be achieved.

Embodiments of the present disclosure provide a solution for sidelink communications so as to solve the above problems and one or more of other potential problems. According to the solution, if a first terminal device determines that a first candidate resource immediately preceding a second resource is available in a candidate resource set, the first terminal device selects the first candidate resource for the sidelink communications. The second resource is reserved by a second terminal device. Then, the first terminal device obtains a Channel Occupancy Time (COT) duration before performing the sidelink communications on the first candidate resource. In turn, the first terminal device transmits first information about the COT duration to the second terminal device. This solution may make resources for sidelink terminal devices consecutive in a COT duration.

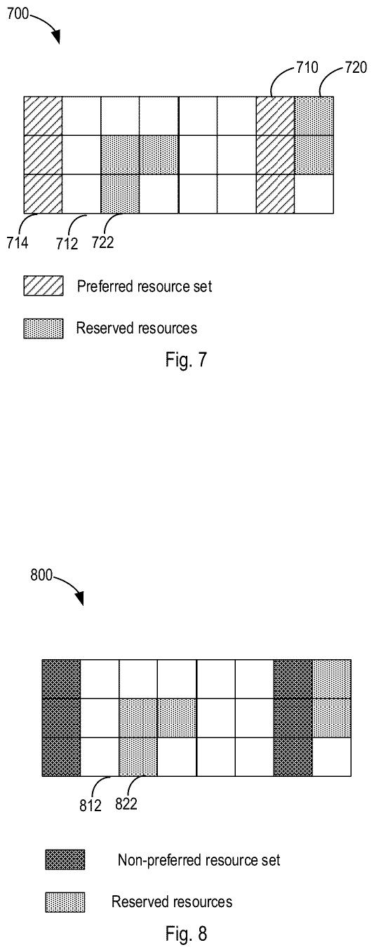

Hereinafter, principle of the present disclosure will be described with reference to FIGS. 5 to 8. FIG. 5 illustrates a flowchart of an example method 500 in accordance with some embodiments of the present disclosure. In some embodiments, the method 500 can be implemented at a terminal device, such as one of the first terminal device 110, the second terminal device 120 and the third terminal device 130 as shown in FIG. 1. For the purpose of discussion, the method 500 will be described with reference to FIG. 1 as performed by the first terminal device 110 without loss of generality.

At block 510, the first terminal device 110 determines whether a first candidate resource immediately preceding a second resource is available in a candidate resource set. The second resource is reserved by the second terminal device 120.

If the first candidate resource immediately preceding the second resource is available in the candidate resource set, the first terminal device 110 selects, at block 520, the first candidate resource for the sidelink communications.

At block 530, the first terminal device 110 obtains a COT duration before performing the sidelink communications on the first candidate resource.

In some embodiments, the first terminal device 110 may obtain the COT duration by performing a channel access procedure. The channel access procedure is also referred to as a listen before talk (LBT) procedure. The LBT procedure may be a type 1 LBT procedure, a type 2A LBT procedure, a type 2B LBT procedure or a type 2C LBT procedure.

At block 540, the first terminal device 110 transmits first information about the COT duration to the second terminal device 120.

The method 500 may make resources for sidelink terminal devices consecutive in a COT duration.

In some embodiments, if the first candidate resource immediately preceding the second resource is unavailable in the candidate resource set, the first terminal device 110 may randomly select a candidate resource in the candidate resource set for the sidelink communications. In other words, if the first terminal device 110 has a sensing result, the first terminal device 110 may select the first candidate resource immediately preceding the second resource with the highest priority and select other candidate resources in the candidate resource set with the second highest priority.

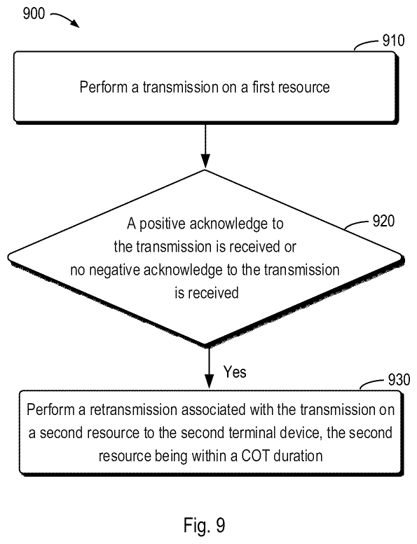

Hereinafter, some examples of a resource selection will be described with reference to FIGS. 6A and 6B. FIG. 6A illustrates an example of a resource selection in accordance with some embodiments of the present disclosure. In this example, a candidate resource 610 immediately preceding a reserved resource 620 is available in a candidate resource set 600, and a candidate resource 612 immediately preceding a reserved resource 622 is available in the candidate resource set 600. Thus, the first terminal device 110 may select at least one of the candidate resources 610 and 612 for sidelink communications.

In case where the first terminal device 110 selects the candidate resource 610, the first terminal device 110 may obtain a COT duration before performing the sidelink communications on the candidate resource 610. In turn, the first terminal device 110 may transmit information about the COT duration to the second terminal device 120. In this way, consecutive resources 612 and 620 in the COT duration may be used by the first terminal device 110 and the second terminal device 120.

FIG. 6B illustrates another example of a resource selection in accordance with some embodiments of the present disclosure. The example in FIG. 6B is similar to the example in FIG. 4. The example in FIG. 6B is different from the example in FIG. 4 in that the first terminal device 110 does not randomly selects a candidate resource from the candidate resource set with the candidate resources 412 and 422 being excluded. Instead, the first terminal device 110 selects at least one of the candidate resources 630 and 632 for sidelink communications. For example, the first terminal device 110 may select the candidate resource 630 for a transmission and the candidate resource 632 for a retransmission associated with the transmission. The transmission on the candidate resource 630 may be an initial transmission or a retransmission. In case where the transmission on the candidate resource 630 is a retransmission, the retransmission on the candidate resource 632 is a next retransmission associated with the retransmission on the candidate resource 630.

Before performing the transmission on the candidate resource 630, the first terminal device 110 may obtain a COT duration 640. In turn, the first terminal device 110 may transmit information about the COT duration 640 to at least one of the second terminal device 120 and the third terminal device 130. Within the shared COT duration 640, the second terminal device 120 and the third terminal device 130 may perform their respective sidelink transmissions by performing a short listen before talk (LBT) procedure (for example, a type 2 LBT procedure). In this way, consecutive resources 630, 412, 632 and 422 in the COT duration 640 may be used by the first terminal device 110, the second terminal device 120 and the third terminal device 130.

In some embodiments, additionally, the first terminal device 110 may receive, from the third terminal device 130, second information about a preferred resource set for the sidelink communications. In such embodiments, the first terminal device 110 may further determine whether the first candidate resource belongs to the preferred resource set. If the first candidate resource belongs to the preferred resource set, the first terminal device 110 selects the first candidate resource.

In other words, if the first terminal device 110 has the sensing result and received the preferred resource set, the first terminal device 110 may select a candidate resource immediately preceding a reserved resource and belonging to the preferred resource set with the highest priority. This will be described with reference to FIG. 7.

FIG. 7 illustrates an example of a resource selection in accordance with some embodiments of the present disclosure. In this example, a candidate resource 710 immediately preceding a reserved resource 720 and belonging to the preferred resource set is available in a candidate resource set 700. Thus, the first terminal device 110 may select the candidate resource 710 for sidelink communications with the highest priority.

In embodiments where the first terminal device 110 has the sensing result and received the preferred resource set, if the first candidate resource immediately preceding the second resource and belonging to the preferred resource set is unavailable, the first terminal device 110 may select a third resource or a fourth resource in the candidate resource set for the sidelink communications. The third candidate resource belongs to the preferred resource set and the fourth resource is immediately preceding the second resource.

In embodiments where the first candidate resource immediately preceding the second resource and belonging to the preferred resource set is unavailable, the first terminal device 110 may determine whether the third candidate resource belonging to the preferred resource set is available. If the third candidate resource is available, the first terminal device 110 may select the third resource. On the other hand, if the third candidate resource is unavailable, the first terminal device 110 may select the fourth resource immediately preceding the second resource. In such embodiments, the first terminal device 110 may select the third resource belonging to the preferred resource set with the second highest priority and select the fourth resource immediately preceding the second resource with the third highest priority. This will also be described with reference to FIG. 7.

As shown in FIG. 7, a candidate resource 712 is immediately preceding a reserved resource 722 but does not belong to the preferred resource set. A candidate resource 714 belongs to the preferred resource set but is not immediately preceding the reserved resource 722. In some embodiments, the first terminal device 110 may select the candidate resource 714 with the second highest priority and the candidate resource 712 with the third highest priority. Because the candidate resource 714 belongs to the preferred resource set, probability of successful sidelink transmission may be increased if the candidate resource 714 is selected with the second highest priority.

Alternatively, in embodiments where the first candidate resource immediately preceding the second resource and belonging to the preferred resource set is unavailable, the first terminal device 110 may determine whether the fourth candidate resource immediately preceding the second resource is available. If the fourth candidate resource is available, the first terminal device 110 may select the fourth resource. On the other hand, if the fourth candidate resource is unavailable, the first terminal device 110 may select the third resource belonging to the preferred resource set. In such embodiments, the first terminal device 110 may select the third resource belonging to the preferred resource set with the second highest priority and select the fourth resource immediately preceding the second resource with the third highest priority. If none of the first, third and fourth candidate resources is available, the first terminal device 110 may randomly select at least one other candidate resource in the candidate resource set. This will also be described with reference to FIG. 7.

As shown in FIG. 7, in some embodiments, the first terminal device 110 may select the candidate resource 712 with the second highest priority and the candidate resource 714 with the third highest priority. Because the candidate resource 712 is immediately preceding the reserved resource 722, consecutive resources 712 and 722 in a COT duration may be used by the first terminal device 110 and the second terminal device 120.

In some embodiments, additionally, the first terminal device 110 may receive, from a fourth terminal device, third information about a non-preferred resource set for the sidelink communications. In such embodiments, the first terminal device 110 may further determine whether the first candidate resource belongs to the non-preferred resource set. If the first candidate resource does not belong to the non-preferred resource set, the first terminal device 110 selects the first candidate resource.

In other words, if the first terminal device 110 has the sensing result and received the non-preferred resource set, the first terminal device 110 may select a candidate resource immediately preceding a reserved resource and not belonging to the non-preferred resource set with the highest priority. If the first candidate resource immediately preceding a reserved resource and not belonging to the non-preferred resource set is available, the first terminal device 110 may randomly select, with the second highest priority, at least one other candidate resource in the candidate resource set by excluding the non-preferred resource set. This will be described with reference to FIG. 8.

FIG. 8 illustrates an example of a resource selection in accordance with some embodiments of the present disclosure. In this example, a candidate resource 810 immediately preceding a reserved resource 820 and not belong to a non-preferred resource set is available in a candidate resource set 800. Thus, the first terminal device 110 may select the candidate resource 810 for sidelink communications with the highest priority.

It will be understood that similar to the examples in FIGS. 6A and 6B, in the examples in FIGS. 7 and 8, upon selecting a candidate resource, the first terminal device 110 may obtain a COT duration before performing the sidelink communications on the candidate resource. In turn, the first terminal device 110 may transmit information about the COT duration to the second terminal device 120.

In embodiments where the first candidate resource immediately preceding the second resource is available, the first terminal device 110 may determine whether a fifth candidate resource immediately preceding a sixth resource is available in the candidate resource set. The sixth resource is reserved by a fourth terminal device. if the fifth candidate resource is available, the first terminal device 110 may select one of the first and fifth candidate resources for the sidelink communications.

In embodiments where the first candidate resource is preceding the fifth candidate resource, the first terminal device 110 may select the first candidate resource. This will be described with reference to FIG. 6A.

As shown in FIG. 6A, the candidate resource 610 is immediately preceding the reserved resource 620, and the candidate resource 612 is immediately preceding the reserved resource 622. If only one candidate resource is needed for sidelink communications, the first terminal device 110 may randomly select one of the candidate resources 610 and 612 for the sidelink communications. Alternatively, because the candidate resource 610 is preceding the candidate resource 612, the first terminal device 110 may select the candidate resource 610 for the sidelink communications. In this way, latency for the sidelink communications may be reduced.

In some embodiments, the first terminal device 110 may have no sensing result. In such embodiments, the first terminal device 110 may randomly select at least one candidate resource in the candidate resource set for the sidelink communications.

As described with reference to FIG. 6B, the first terminal device 110 may select the candidate resource 630 for a transmission and the candidate resource 632 for a retransmission associated with the transmission. If the retransmission is not performed on the candidate resource 632, the first terminal device 110 will lose the COT duration 640. Similarly, the second terminal device 120 may reserve the resource 412 for its retransmission, and the third terminal device 130 may reserve the resource 422 for its retransmission. If the retransmission is not performed on the candidate resource 412 and 422, the second terminal device 120 and the third terminal device 130 will also lose the COT duration 640 shared by the first terminal device 110.

Embodiments of the present disclosure provide another solution for sidelink communications so as to solve the above problems and one or more of other potential problems. According to the solution, if a positive acknowledge to the transmission is received or no negative acknowledge to the transmission is received from a second terminal device, a first terminal device performs a retransmission associated with the transmission on a second resource to the second terminal device. The second resource is within a Channel Occupancy Time (COT) duration.

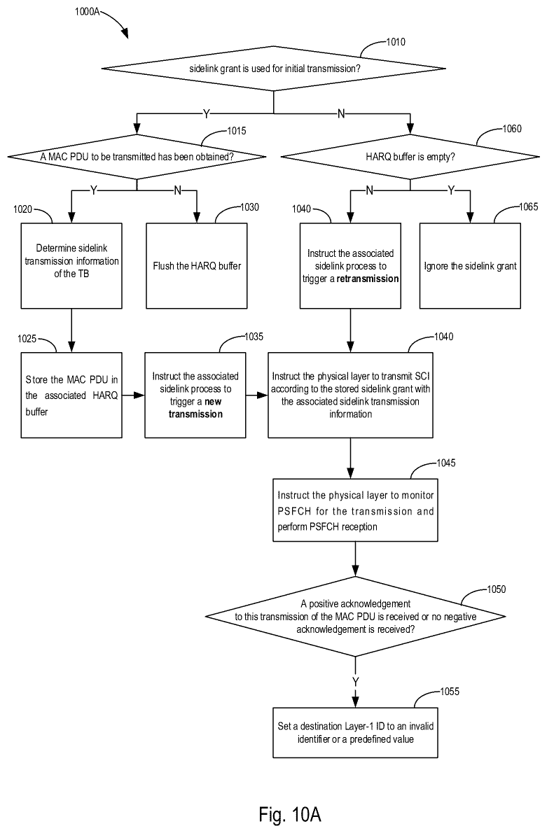

Hereinafter, principle of the present disclosure will be described with reference to FIGS. 9 to 11. FIG. 9 illustrates a flowchart of an example method 900 in accordance with some embodiments of the present disclosure. In some embodiments, the method 900 can be implemented at a terminal device, such as one of the first terminal device 110, the second terminal device 120 and the third terminal device 130 as shown in FIG. 1. For the purpose of discussion, the method 900 will be described with reference to FIG. 1 as performed by the first terminal device 110 without loss of generality.

At block 910, the first terminal device 110 performs a transmission on a first resource.

At block 920, the first terminal device 110 determines whether a positive acknowledge to the transmission is received or no negative acknowledge to the transmission is received from the second terminal device 120.

If the positive acknowledge to the transmission is received or no negative acknowledge to the transmission is received, at block 930, the first terminal device 110 performs a retransmission to the second terminal device 120 on a second resource. The retransmission is associated with the transmission on the first resource. The second resource is within a COT duration.

The transmission on the first resource may be an initial transmission or a retransmission. In embodiments where the transmission on the first resource is a retransmission, the retransmission on the second resource is a next retransmission associated with the retransmission on the first resource.

With the method 900, the first terminal device 110 still performs the retransmission if the positive acknowledge to the transmission is received or no negative acknowledge to the transmission is received. In this way, the first terminal device 110 will not lose the COT duration. In other words, the first terminal device 110 may maintain the COT duration.

In some embodiments, the first resource is within the COT duration and the COT duration is obtained by the first terminal device 110. Consider the example in FIG. 6B. In this example, the first terminal device 110 may perform a transmission on the resource 630. If a positive acknowledge to the transmission is received or no negative acknowledge to the transmission is received, the first terminal device 110 may perform a retransmission associated with the transmission on the resource 632. Both the resource 630 and the resource 632 are within the COT duration 640 obtained by the first terminal device 110.

In some embodiments, the COT duration may be shared by other terminal device. In such embodiments, the second resource is within the COT duration and the first resource may be out of the COT duration. Still consider the example in FIG. 6B. In this example, the second terminal device 120 may perform a transmission with the SCI 410 on a resource preceding the COT duration 640. If a positive acknowledge to the transmission is received or no negative acknowledge to the transmission is received, the second terminal device 120 may perform a retransmission associated with the transmission on the resource 412 within the COT duration 640 shared by the first terminal device 110.

In some embodiments, if the positive acknowledge is received or no negative acknowledge is received, the first terminal device 110 may set a destination Layer-1 identifier (ID) for the second terminal device 120 to an invalid ID or a predefined value. In such embodiments, the first terminal device 110 may perform the retransmission based on the destination Layer-1 ID. For example, the predefined value may be all “0”. By setting the destination Layer-1 ID for the second terminal device 120 to the invalid ID or the predefined value, the retransmission will not reach the second terminal device 120. Thus, repetitive decoding may be avoided in the second terminal device 120. As such, processing complexity of the second terminal device 120 will not be increased.

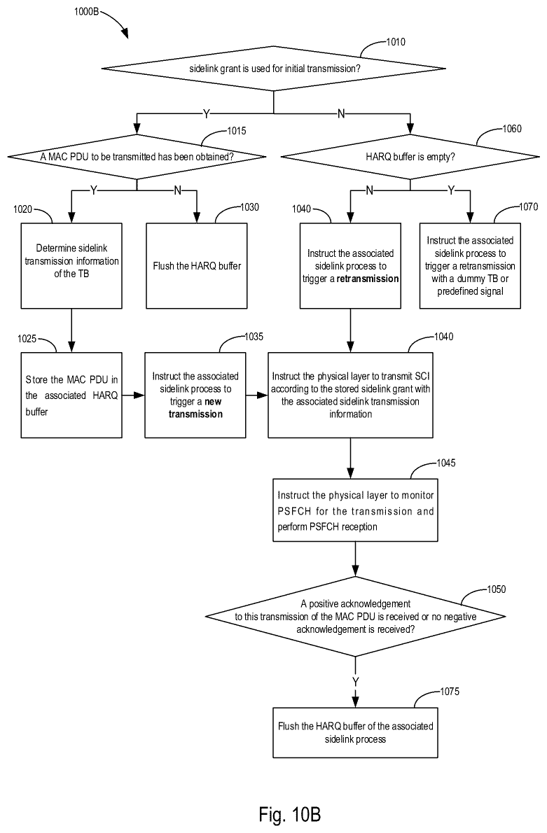

In some embodiments, the first terminal device 110 may transmit, based on the destination Layer-1 ID, a transport block (TB) associated with the transmission. This will be described with reference to FIG. 10A.

FIG. 10A illustrates a flowchart of an example method 1000A in accordance with some embodiments of the present disclosure. The method 1000A may be considered as an example implementation of the method 900. In some embodiments, the method 1000A can be implemented at a terminal device, such as one of the first terminal device 110, the second terminal device 120 and the third terminal device 130 as shown in FIG. 1. For the purpose of discussion, the method 1000A will be described with reference to FIG. 1 as performed by the first terminal device 110 without loss of generality.

It shall be understood that a candidate resource may correspond to sidelink grant. Hereinafter, the candidate resource and the sidelink grant may be used interchangeably.

At block 1010, a media access control (MAC) entity of the first terminal device 110 determines whether a sidelink grant is used for an initial transmission or a retransmission associated with the initial transmission.

If the sidelink grant is used for the initial transmission, the MAC entity determines, at block 1015, whether a MAC packet data unit (PDU) to be transmitted has been obtained.

If the MAC PDU to be transmitted has not been obtained, the MAC entity flushes the HARQ buffer at block 1030.

On the other hand, if the MAC PDU to be transmitted has been obtained, the MAC entity determines, at block 1020, sidelink transmission information of a TB associated with the MAC PDU. Then, the MAC entity stores, at block 1025, the MAC PDU and the sidelink transmission information in an associated Hybrid Automatic Repeat Request (HARQ) buffer.

At block 1035, the MAC entity instructs the associated sidelink process to trigger a new transmission. Then, at block 1040, the MAC entity instructs a physical layer of the first terminal device 110 to transmit SCI and the MAC PDU according to the stored sidelink grant with the associated sidelink transmission information.

At block 1045, the MAC entity instructs the physical layer to monitor PSFCH for the transmission and perform PSFCH reception.

At block 1050, the MAC entity determines whether a positive acknowledge to the transmission of the MAC PDU is received or no negative acknowledge to the transmission of the MAC PDU is received.

It will be understood that in the prior art, if the positive acknowledge to the transmission of the MAC PDU is received or no negative acknowledge to the transmission of the MAC PDU is received, the MAC entity will flush the HARQ buffer of the associated sidelink process. However, in the method 1000, if the positive acknowledge to the transmission of the MAC PDU is received or no negative acknowledge to the transmission of the MAC PDU is received, the MAC entity modifies, at block 1055, the sidelink transmission information of the TB stored in the HARQ buffer by setting a destination Layer-1 ID to an invalid ID or a predefined value. For example, the predefined value may be all “0”.

At block 1010, if the MAC entity determines a sidelink grant is used for a retransmission, the MAC entity may further determine, at block 1060, whether the HARQ buffer is empty. Because at block 1055, the MAC entity did not flush the HARQ buffer as it did in the prior art, the MAC entity may determine, at block 1060, the HARQ buffer is not empty. Thus, the method will proceed to block 1040, at which the first terminal device 110 may retransmit the TB associated with the transmission based on the destination Layer-1 ID which was set at block 1055. As such, the retransmitted TB will not reach the second terminal device 120. Thus, repetitive decoding may be avoided in the second terminal device 120. As such, processing complexity of the second terminal device 120 will not be increased.

On the other hand, if the MAC entity determines, at block 1060, the HARQ buffer is empty, the method will proceed to block 1065, at which the MAC entity ignores the sidelink grant.

Alternatively, in some embodiments, the first terminal device 110 may not transmit the TB associated with the transmission. Instead, the first terminal device 110 may transmit a dummy TB based on the destination Layer-1 ID. Alternatively, in some embodiments, in order to perform the retransmission, the first terminal device 110 may transmit a predefined signal and predefined sidelink transmission information. This will be described with reference to FIG. 10B.

FIG. 10B illustrates a flowchart of an example method 1000B in accordance with some embodiments of the present disclosure. The method 1000B may be considered as another example implementation of the method 900. In some embodiments, the method 1000B can be implemented at a terminal device, such as one of the first terminal device 110, the second terminal device 120 and the third terminal device 130 as shown in FIG. 1. For the purpose of discussion, the method 1000B will be described with reference to FIG. 1 as performed by the first terminal device 110 without loss of generality.

In the method 1000B, actions at blocks 1010, 1015, 1020, 1025, 1030, 1035, 1040, 1045, 1050 are the same as those in the method 1000A. Thus, for brevity, the details of these actions will not be described.

The method 1000B is different from the method 1000A at blocks 1070 and 1075. If the MAC entity determines, at block 1060, the HARQ buffer is empty (which means a positive acknowledge to the transmission is received or no negative acknowledge to the transmission is received), the method will proceed to block 1070. At block 1070, the MAC entity may instruct the associated sidelink process to trigger a retransmission with a dummy TB with the destination Layer-1 ID being set to an invalid value or predefined value. Alternatively, at block 1070, the MAC entity may instruct the associated sidelink process to trigger a retransmission with a predefined MAC PDU and predefined sidelink transmission information. In this way, the dummy TB or the predefined MAC PDU may reach the second terminal device 120. Thus, repetitive decoding may be avoided at the second terminal device 120. As such, processing complexity of the second terminal device 120 will not be increased.

In addition, at block 1075, the MAC entity flushes the HARQ buffer of the associated sidelink process.

In some embodiments, in order to avoid repetitive decoding at the second terminal device 120, SCI fields in the associated PSCCH or SCI may be adjusted. For example, frequency resource assignment and time resource assignment in the associated PSCCH or SCI shall be set to code point that corresponding to NO reserved resources.

In some embodiments, the first terminal device 110, the second terminal device 120 or the third terminal device 130 may perform the methods 900, 1000A and 1000B on retransmission resources that are within a COT duration.

In some embodiments, if the positive acknowledge to the transmission is received or no negative acknowledge to the transmission is received, a physical layer of a terminal device may perform a retransmission. In such embodiments, the physical layer may transmit a dummy TB or a predefined signal and SCI. The SCI indicates that the dummy transport block or the predefined signal is not to be decoded. For example, the field “destination ID” in the SCI may be set to an invalid/predefined value to implicitly indicate the dummy transport block or the predefined signal is not to be decoded. Alternatively, one bit in the SCI may explicitly indicate that the dummy transport block or the predefined signal is not to be decoded.

In some embodiments, Table 1 shows a change in IS 38.321 associated with the example method 900 or 1000A.

TABLE 1
5.22.1.3.1a Sidelink process
...omitted...
1> if sl-MaxTransNum corresponding to the highest priority of the logical
channel(s) in the MAC PDU has been configured in
sl-CG-MaxTransNumList for the sidelink grant by RRC and the number
of transmissions of the MAC PDU has been reached to sl-MaxTransNum;
or

| | |
|---|---|
| ♦ | 2> flush the HARQ buffer of the associated Sidelink process. |

1> if a positive acknowledgement to this transmission of the MAC PDU
was received according to clause 5.22.1.3.2; or
1> if negative-only acknowledgement was enabled in the SCI and no
negative acknowledgement was received for this transmission of the
MAC PDU according to clause 5.22.1.3.2:

| | |
|---|---|
| ♦ | 2> modify the at least following sidelink transmission |
| | information of the TB stored in the HARQ buffer: |
| | 5> set the Destination Layer-1 ID to an invalid ID or |
| | predefined value (e.g., all “0”) |
| | ... |

In some embodiments, Table 2 shows a change in TS 38.321 associated with the example method 900 or 1000B.

TABLE 2
5.22.1.3.1 Sidelink HARQ Entity
•••omitted...
1>else (i.e. retransmission):

| ♦ | 2>if the HARQ Process ID corresponding to the sidelink grant | |
|---|---|---|
| | received on PDCCH, the configured sidelink grant or the selected | |
| | sidelink grant is associated to a Sidelink process of which HARQ | |
| | buffer is empty; | |
| | • | Instruct the associated Sidelink process to trigger a |
| | | retransmission with a dummy TB with at least following |
| | | sidelink transmission information, |

| | |
|---|---|
| - | e.g., set the Destination Layer-1 ID to an invalid |
| | value or predefined value; or |

| | • | Instruct the associated Sidelink process to trigger a |
|---|---|---|
| | | retransmission with a predefined MAC PDU with |
| | | predefined sidelink transmission information; |
| ♦ | 2>if the HARQ Process ID corresponding to the sidelink grant | |
| | received on PDCCH is not associated to any Sidelink process: | |
| | • | 3>ignore the sidelink grant. |
| ♦ | 2>else: | |
| | • | 3>identify the Sidelink process associated with this grant, |
| | | and for the associated Sidelink process: |

| - | 4> | deliver the sidelink grant of the MAC PDU to the |
|---|---|---|
| | associated Sidelink process; | |
| - | 4> | instruct the associated Sidelink process to trigger a |
| | | retransmission. |

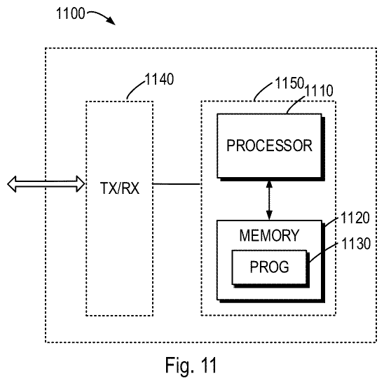

FIG. 11 is a simplified block diagram of a device 1100 that is suitable for implementing some embodiments of the present disclosure. The device 1100 can be considered as a further example embodiment of the first terminal device 110 as shown in FIG. 1. Accordingly, the device 1100 can be implemented at or as at least a part of the terminal device 110.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 12. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a first terminal device, comprising:
transmitting information about a channel occupancy duration to a second terminal device after performing a channel access procedure, wherein:
the information indicates whether the channel occupancy duration can be shared to a reservation of a second resource, and
the second resource is a reserved resource of the second terminal device; and
performing sidelink transmission using a first resource before the second resource.

22. The method of claim 21, wherein channel access procedure is a type 1 channel access procedure.

23. The method of claim 21, further comprising:
determining a resource set;
selecting, from the resource set, the first resource for the sidelink transmission, the first resource being before the second resource.

24. A terminal device, comprising a processor configured to:
transmit information about a channel occupancy duration to a second terminal device after performing a channel access procedure, wherein:
the information indicates whether the channel occupancy duration can be shared to a reservation of a second resource, and
the second resource is a reserved resource of the second terminal device; and
performing sidelink transmission using a first resource before the second resource.

25. The terminal device of claim 24, wherein channel access procedure is a type 1 channel access procedure.

26. The terminal device of claim 24, wherein the processor is further configured to cause the terminal device to:
determining a resource set;
selecting, from the resource set, the first resource for the sidelink transmission, the first resource being before the second resource.
